(19) United States
(12) Patent Application Publication
(10) Pub. No.: US 2006/0188309 A1
(43) Pub. Date: Aug. 24, 2006

(54) Sheet processing apparatus

(75) Inventors: Masao Akaiwa, Shiojiri-shi (JP); Kenichi Nakajima, Nagano-ken (JP); Takayuki Uehara, Koshigaya-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/342,071

(22) Filed: Jan. 27, 2006

(30) Foreign Application Priority Data
Feb. 24, 2005 (JP) 2005-049582

(51) Int. Cl. B41J 3/32

(52) U.S. Cl. 400/109.1

(57) ABSTRACT

There is provided a sheet processing apparatus in which a braille character is embossed on a process sheet, which is manually inserted from a sheet inserting part provided at one end of a sheet traveling path, by a braille-characters embossing device facing on the sheet traveling path, wherein the sheet inserting part is provided with visually recognizable insertion-part indicating information as an indication for inserting the process sheet.

The entire disclosure of Japanese Patent Application No. 2005-049582, filed Feb. 24, 2005, is expressly incorporated by reference herein.

### BACKGROUND

1. Technical Field

The present invention relates to a sheet processing apparatus for embossing braille characters on a process sheet which is manually inserted.

2. Related Art

Known sheet processing apparatuses for printing and embossing both ink characters and braille characters on a process sheet so that visually-normal people can recognize the meanings of braille characters are of a type including a feeding device for feeding the process sheet, a printing device having a thermal head for printing ink characters, and an embossing device having a plurality of embossing pins for embossing braille characters. According to the sheet processing apparatuses, the printing device prints ink characters on the upper-half area of the process sheet and the embossing device embosses braille characters on the lower-half area thereof, thereby providing a process sheet having both ink characters and braille characters formed thereon. In other words, the sheet processing apparatuses simultaneously perform printing and embossing operations while the process sheet is fed. JP A-2001-88358 is an example of related art.

According to the known sheet processing apparatuses described above, when the embossing device performs an embossing operation, the process sheet is separated from the thermal head due to the embossing vibration caused thereby, which in turn deteriorates the quality of ink-characters printing.

In order to solve the above-described problem, on the other hand, there is employed a configuration in which the printing device and the embossing device are independently or separately provided from each other, and after ink characters are printed on the process sheet by the printing device, the process sheet is manually inserted into the embossing device and embossed in braille (two-pass method).

In accordance with the two-pass method, however, there may occur cases, depending on the configuration of apparatuses involved, in which the ejecting direction of the printed process sheet and the manual inserting direction are not parallel with each other, and a sheet inserting part and a sheet ejecting part are difficult to distinguish from each other during a manual insertion of the process sheet into the printing device. This could cause the user to hesitate to insert the printed process sheet.

### SUMMARY

It is an advantage of the invention to provide a sheet processing apparatus into which a process sheet is manually inserted and which is capable of notifying the user of a sheet inserting part.

According to the invention, there is provided a sheet processing apparatus in which a braille character is embossed on a process sheet, which is manually inserted from a sheet inserting part provided at one end of a sheet traveling path, by a braille-characters embossing device facing on the sheet traveling path, wherein the sheet inserting part is provided with visually recognizable insertion-part indicating information as an indication for inserting the process sheet.

According to this configuration, the sheet inserting part is provided with the insertion-part indicating information as an indication for inserting the process sheet. Therefore, when manually inserting the process sheet, the user can visually recognize the sheet inserting part and insert the process sheet with full confidence and use the apparatus as a user-friendly sheet processing apparatus.

In this case, it is preferable that the braille-characters embossing device be disposed at a position biased to one side in the width direction of the sheet processing apparatus, and the insertion-part indicating information be provided so as to correspond to the position of the braille-characters embossing device disposed in the width direction of the sheet traveling path.

According to this configuration, the user can predict on which part of the process sheet braille characters will be embossed by the braille-characters embossing device. Therefore, even when a process sheet having a small width is inserted into the sheet inserting part designed for a process sheet having the maximum width, the user cannot fail to identify the inserting direction in the width direction.

In this case, it is preferable that the insertion-part indicating information include direction indicating information for indicating an inserting direction.

According to this configuration, the user can confirm an inserting direction when the process sheet is inserted into the sheet inserting part. Therefore, the user's manual inserting operation can be smoothly performed.

In this case, it is preferable that the insertion-part indicating information include braille-characters image information for displaying braille-character images.

According to this configuration, the user can learn the sheet inserting part for embossing braille characters and a position in the width direction thereof.

In this case, it is preferable that the insertion-part indicating information be recessed in a base plate of the sheet inserting part communicating with the sheet traveling path.

According to this configuration, the insertion-part indicating information is recessed in the base plate of the sheet inserting part. Therefore, even if the process sheet faces on the sheet inserting part and comes into contact with the insertion-part indicating information, the insertion-part indicating information will not get caught or run into any other path interference and continue to serve as an indication for many years to come.

In this case, it is preferable that the sheet processing apparatus further comprise a printing device for printing an ink character on the process sheet, and the printing device print, on the tip-end part of the process sheet in the inserting direction thereof, sheet-insertion indicating information on the direction of insertion into the sheet insertion part.

According to this configuration, the user can manually insert the process sheet into the sheet inserting part with its sheet-insertion indicating information put on the leading edge, which enables the user to insert the process sheet into the sheet inserting part without taking a wrong direction.

In this case, it is preferable that the sheet insertion part include a guide device for guiding the insertion of the process sheet, and the printing device perform a printing operation such that the insertion-part indicating information and the sheet-insertion indicating information of the process sheet whose insertion is guided by the guide device correspond to each other in the width direction of the sheet traveling path.

According to this configuration, the process sheet inserted into the sheet inserting part is controlled by the guide device to face on the sheet traveling path. At this time, the insertion-part indicating information and the sheet-insertion indicating information correspond to each other in position in the width direction of the sheet traveling path. Therefore, the user cannot fail to identify an inserting direction in the width direction, and the user's manual inserting operation can be smoothly performed.

In this case, it is preferable that the process sheet be composed of a recording sheet whose rear surface is coated with an adhesive agent and a peeling sheet affixed to the rear surface of the recording sheet with the adhesive agent, a half-cutting device for cutting only the recording sheet of the process sheet at the tip-end part in the inserting direction thereof be further provided, and the printing device print the sheet-insertion indicating information on a margin of the recording sheet which is cut by the half-cutting device.

According to this configuration, the recording sheet of the process sheet having ink characters and braille character formed thereon is affixed to an accompanying object with an adhesive agent. At this time, the half-cutting device forms a part not to be adhered to the accompanying object, i.e., a margin, where the sheet-insertion indicating information is printed, and no sheet-insertion indicating information is left on the recording sheet which has been adhered to the accompanying object.

In this case, it is preferable that the sheet-insertion indicating information and the insertion-part indicating information be similar in design.

According to this configuration, after visually recognizing the sheet-insertion indicating information of the process sheet and the insertion-part indicating information of the sheet inserting part, the user manually inserts the process sheet. At this time, the above-described information for indicating the sheet are similar in design. Therefore, the indicating information on visual recognition correspond to each other, thereby making it possible for the user to easily recognize the same.

### BRIEF DESCRIPTION OF THE DRAWINGS

The invention will be described with reference to the accompanying drawings, wherein like numbers reference like elements.

FIG. 1 is an external perspective view of a label forming apparatus with its cover closed according to an embodiment.

FIG. 2 is an external perspective view of the label forming apparatus with it cover opened according to an embodiment.

FIG. 3 is a cross-sectional diagram of an embossing unit.

FIG. 4 is a control block diagram of the label forming apparatus.

FIG. 5 is a plan view schematically showing a tape traveling path and a surrounding area thereof.

FIGS. 6A and 6B are a plan view of insertion-part indicating information and a cross-section of the insertion-part indicating information taken along line A-A, respectively.

### DESCRIPTION OF EXEMPLARY EMBODIMENTS

Hereinafter, referring to the accompanying drawings, description will be made about a case in which a sheet processing apparatus according to an embodiment of the invention is applied to a label forming apparatus. The label forming apparatus has an ink-characters printing section and a braille-characters embossing section. The ink-characters printing section performs an ink-characters printing on a process sheet, and the printed part of the process sheet is cut into a tape piece. The tape piece is then manually inserted into the braille-characters embossing section and embossed in braille therein.

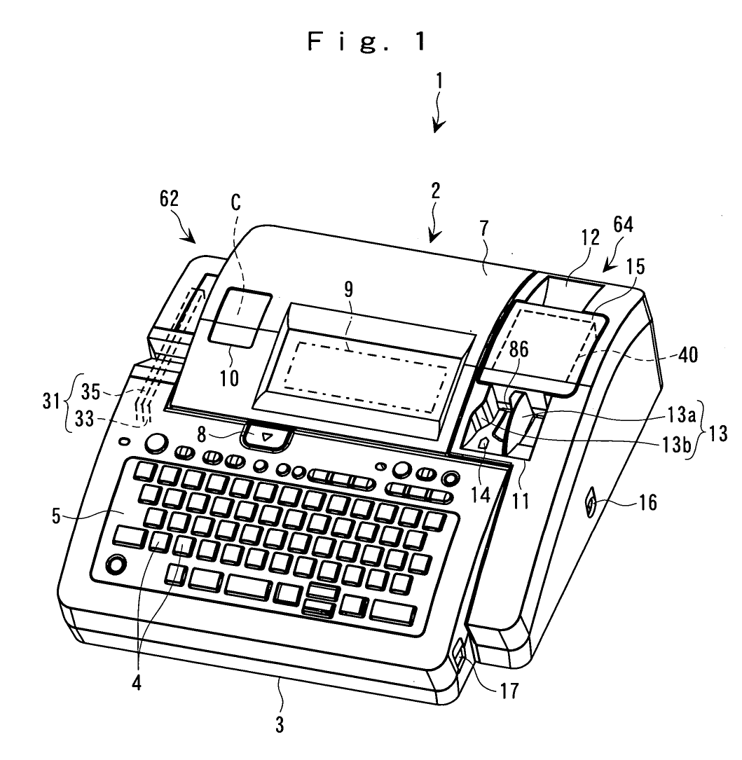

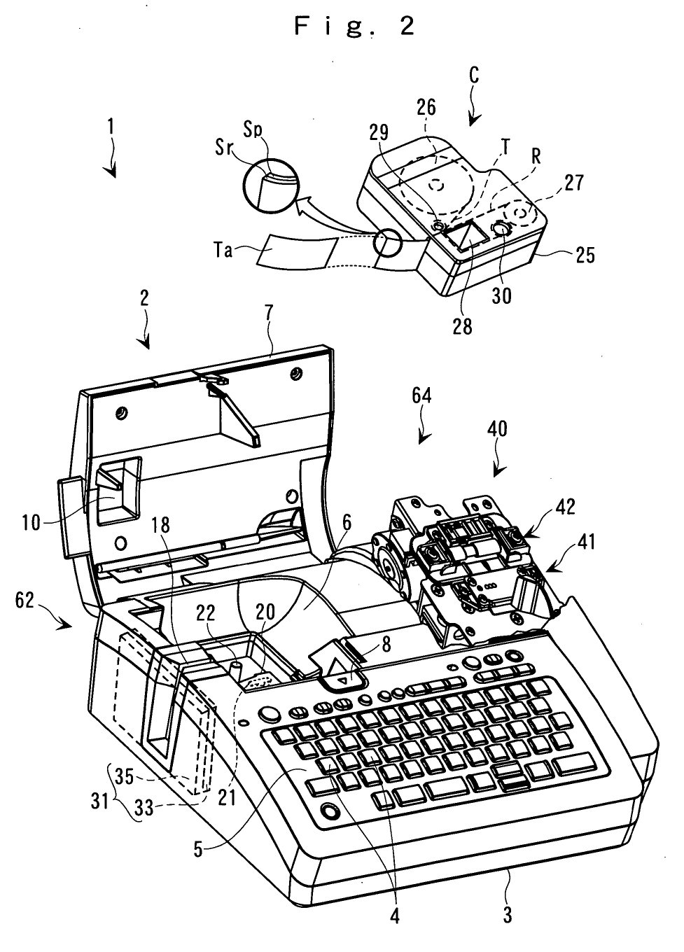

FIGS. 1 and 2 are external perspective views of the label forming apparatus with its cover closed and opened, respectively. As shown in the figures, the label forming apparatus 1 has an apparatus main body 2 which prints ink characters on the process tape T and embosses braille characters on the tape piece Ta of the process tape T and a tape cartridge C accommodating the process tape T and an ink ribbon R and detachably attached to the apparatus main body 2.

The apparatus main body 2 has an outer shell formed by an apparatus casing 3 in which the ink-characters printing section 62 is widely arranged, and the braille-characters embossing section 64 is arranged at the rear-half area on the right side of the apparatus casing 3. The apparatus casing 3 has a keyboard 5 including various keys 4 disposed at the top surface on the front-half side thereof. At the top surface on the rear-half side of the apparatus casing 3 is widely provided an opening and closing lid 7. On the near side of the opening and closing lid 7 is provided a lid opening button 8 for opening the same. On the front side of the opening and closing lid 7 are provided a rectangular display 9 for displaying results or the like inputted from the keyboard 5 and a discrimination window 10 for discriminating the mounting and non-mounting state of the tape cartridge C, which is positioned on the left side of the display 9.

Inside the opening and closing lid 7 is provided a recessed cartridge mounting section 6 for mounting the tape cartridge C. In the cartridge mounting section 6 is disposed a print head 21 for printing ink characters on the process tape T reeled out from the tape cartridge C (see FIG. 2).

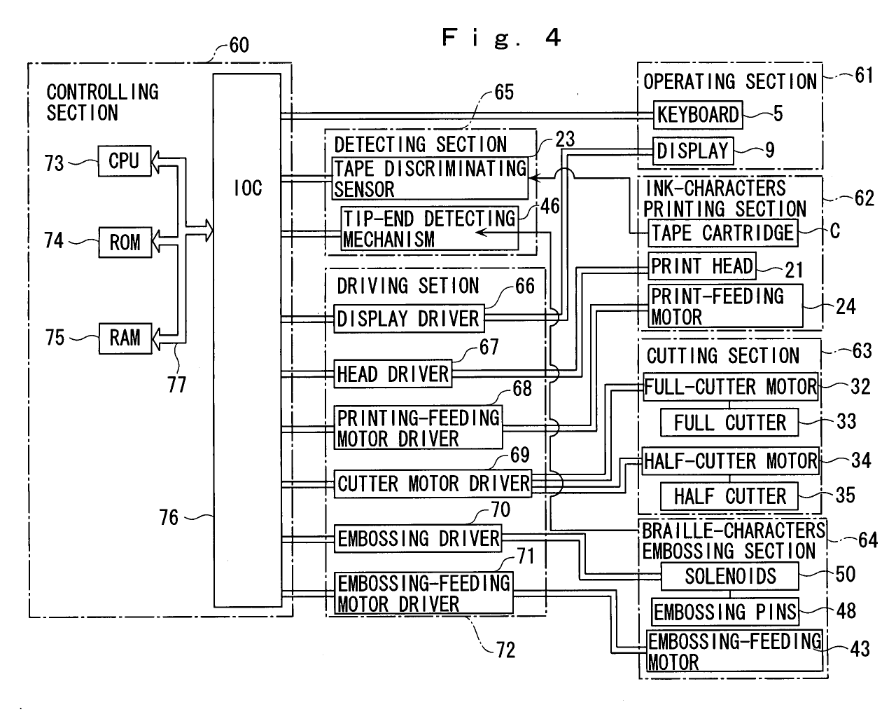

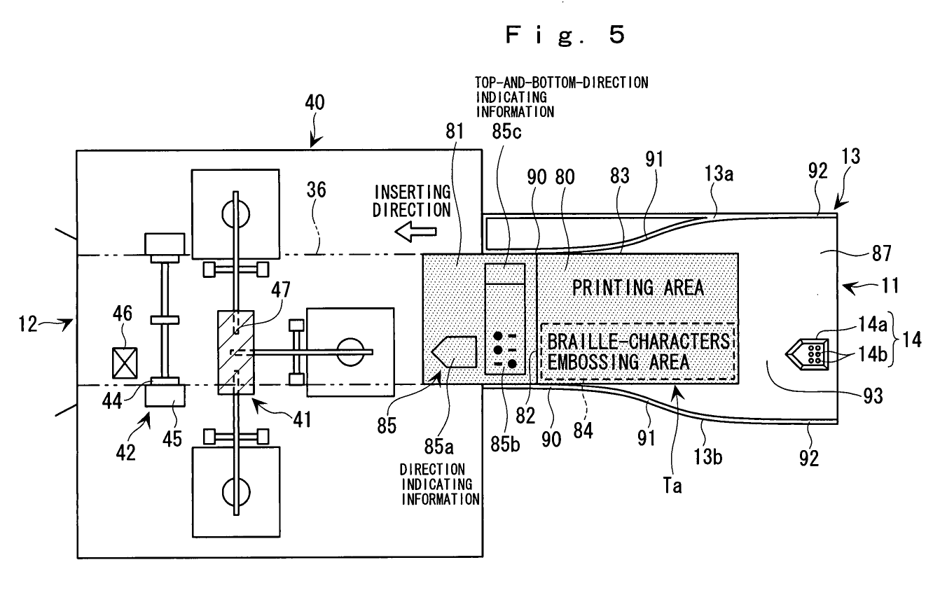

On the left side of the apparatus casing 3 is formed a print-tape ejecting slot 18 for communicating the cartridge mounting section 6 with the outside of the apparatus. The apparatus casing 3 includes a cutter unit 31 for cutting off the process tape T, which faces on the print-tape ejecting slot 18. The cutter unit 31 is disposed so as to face on the print-tape ejecting slot 18 and has a full cutter 33, a half cutter 35, and an ejecting mechanism (see FIG. 4). The full cutter cuts off the process tape T like scissors, the half cutter equipped with a stopper is disposed on the downstream side in the tape-feeding direction relative to the full cutter 33 and driven by a motor (half-cutter motor 34) to cut only the below-described recording tape Sr of the process sheet T like scissors, and the ejecting mechanism is disposed on the downstream side in the tape-feeding direction relative to the half cutter 35 and forcibly ejects the cut tape piece Ta. After this half-cutting operation, the process tape T will have a margin 81 formed at the tip-end part thereof in the direction in which the process tape is inserted into the below-described embossing assembly 40 (see. FIG. 5).

On the other hand, at the right top-surface on the rear-half side of the apparatus casing 3 is disposed a braille-characters embossing section 64. The braille-characters embossing section 64 has an embossing-tape inserting section (sheet inserting section) 11 into which the tape piece Ta is manually inserted from the front side of the embossing-tape inserting section with its printing surface directed upward and an embossing-tape ejecting section 12 from which the tape piece Ta embossed in braille is ejected backward, between which is interposed an embossing assembly 40 serving as the main body of the braille-characters embossing section 64. As described in detail below, the embossing-tape inserting section 11 is provided with a manual inserting guide 13 and insertion-part indicating information 14 as an indication for inserting the tape piece Ta. The top surface of the embossing assembly 40 is covered with an embossing-section cover 15 so as to prevent foreign materials from being entered therein from the outside. The embossing-section cover 15 is made of a transparent resin and serves also as a check lid.

On the right side of the apparatus casing 3 are formed a power supply port 16 for supplying electric power and a connecting port 17 (interface) for connecting to external devices such as personal computers. According to this configuration, the external devices can be connected to the connecting port 17, which in turn makes it possible to perform an ink-characters printing and a braille-characters embossing based on character information generated by the external devices or the like. Furthermore, although omitted in the figures, the apparatus casing 3 has a circuit board constituting a controlling section 60 (see FIG. 4) for comprehensively controlling the apparatus casing 2 mounted therein.

The cartridge mounting section 6 has the print head 21 having a heater element and covered with a head cover 20, a positioning boss 22 for positioning the below-described tape reel 26, a platen driving shaft (not shown) for feeding the process tape T and the ink ribbon R of the tape cartridge C and placed opposite to the print head 21, and a take-up driving shaft (not shown) for taking up the ink ribbon R, all of which are projectively provided in the cartridge mounting section. Furthermore, at the corner of the cartridge mounting section 6 is provided a tape discriminating sensor 23 (see FIG. 4) composed of a plurality of micro switches. In a bottom plate of the cartridge mounting section 6 are incorporated a print-feeding motor 24 (see FIG. 4) for driving the platen driving shaft and the take-up driving shaft, a reduction gear train (not shown), or the like.

The tape cartridge C has a cartridge casing 25 in which are accommodated a tape reel 26 winding the process tape T, a ribbon feeding reel 27 winding the ink ribbon R, and a ribbon taking-up reel 30. The ribbon feeding reel 27 and the ribbon taking-up reel 30 are positioned on the right lower side of the cartridge casing. Furthermore, around the left lower side of the tape reel 26 is formed a through-hole 28 into which the head cover 20 covering the print head 21 is inserted. Besides, at a position where the process tape T and the ink ribbon R overlap each other is arranged a platen roller 29 which is engaged with the platen driving shaft and rotates therewith.

When the tape cartridge C is mounted on the cartridge mounting section 6, the head cover 20, the positioning boss 22, the take-up driving shaft, and the platen driving shaft are inserted into the through hole 28, the tape reel 26, the ribbon taking-up reel 30, and the platen roller 29, respectively. When the opening and closing lid 7 is closed in this state, the print head 21 and the platen roller 29 are successively brought into contact with each other and sandwich the process tape T and the ink ribbon R therebetween, to create a printing standby state. Then, the platen driving shaft and the take-up driving shaft cyclically rotate based on ink-characters data generated by the controlling section 60 corresponding to character information inputted from the keyboard 5 or the like, and the print head 21 performs an ink-characters printing while the process tape T and the ink ribbon R are fed. At the same time, the ink ribbon R fed out from the ribbon feeding reel 27 travels around walls of the through hole 28 and is taken up by the ribbon taking-up reel 30. On the process tape T printed with ink characters is formed the margin 81 by the half cutter 35, and the printed part of the process tape T is cut by the full cutter 33. The cut tape piece Ta is ejected to the outside from the printing-tape ejecting slot 18.

The process tape T is composed of the recording tape Sr made of PET (polyethylene terephthalate) and having an adhesive agent layer coated on the rear surface thereof and the peeling tape Sp made of PET and affixed to the recording tape Sr with the adhesive agent layer. The process tape T is accommodated in the cartridge casing 25 in a rolled state with its recording tape Sr and peeling tape Sp directed outward and inward, respectively. The process tape T is of two types: one has a tape width of 12 mm and the other has a tape width of 24 mm. On the rear surface of the cartridge casing C are formed a plurality of small holes to be detected (not shown). The tape discriminating sensor 23 described above discriminates the plurality of holes to be detected so that the type of the process tape T can be discriminated.

As shown in FIG. 5, the embossing assembly 40 faces on a tape traveling path 36 linearly connecting the embossing-tape inserting section 11 and the embossing-tape ejecting section 12 and has an embossing unit 41 (braille-characters embossing device) and a tape feeding unit 42. The embossing unit performs a braille-characters embossing and is disposed biased to the half area on the cartridge mounting section 6 side in the width direction of the tape traveling path 36, and the tape feeding unit feeds the tape piece Ta manually inserted from the embossing-tape inserting section 11 to the embossing-tape ejecting section 12.

The tape feeding unit 42 has feeding rollers 44 which are rotated to feed the tape piece Ta, roller-shaft supporting section 45 for pivotally supporting the feeding rollers 44, a reversely rotatable embossing-feeding motor 43 (see FIG. 4) for rotating the feeding rollers 44, a power transmitting mechanism (not shown) for transmitting the power of the embossing-feeding motor 43 to the feeding rollers 44, and a tip-end detecting mechanism 46 for detecting the tip end of the tape piece Ta to be fed. In accordance with the driving of the embossing-feeding motor 43, the feeding rollers 44 are rotated through the power transmitting mechanism to feed the tape piece Ta. The tip-end detecting mechanism 46 detects the tip end of the tape piece Ta fed, as a result of which the embossing unit 41 starts performing a braille-characters embossing.

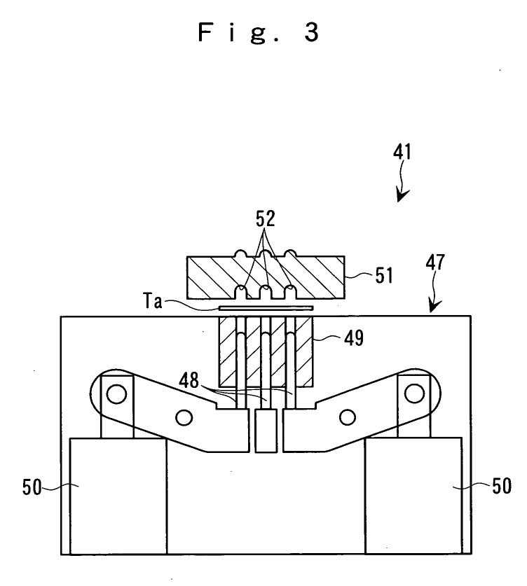

Referring to FIG. 3, the embossing unit 41 is disposed on the upstream side in the tape-feeding direction relative to the feeding rollers 47 and composed of an embossing section 47 provided on the lower side of the inserted tape piece Ta and an embossing receiving section 51 provided at a position opposite to the embossing section 47. The embossing section 47 has three embossing pins 48 arranged to correspond to three vertically-aligned embossing salients of the six embossing salients constituting a braille character (braille character represented by six points, hereinafter), an embossing guide block 49 for guiding the embossing movement of the three embossing pins 48 back and forth, and three solenoids 50 as a driving source. The embossing receiving section 51 has three receiving grooves 52 formed therein corresponding to the three embossing pins 48. While the tape piece Ta is fed by the tape feeding unit 42, the three embossing pins 48 are selectively jumped into the receiving grooves 52 by the three solenoids 50 as the driving source to perform an embossing operation. As a result, the tape piece Ta has an embossing salient made of the so-called six-point braille character formed thereon.

Referring next to FIG. 4, description will be made about a configuration of a control system of the label forming apparatus 1. The label forming apparatus 1 is composed of an operating section 61, the ink-characters printing section 62, a cutting section 63, the braille-characters embossing section 64, a detecting section 65, a driving section 72, and the controlling section 60. The operating section has the keyboard 5 and the display 9 and serves as a user interface by which the user, for example, inputs character information and displays various information. The ink-characters printing section has the tape cartridge C, the print head 21, and the print-feeding motor 24 and prints ink-characters data on the process tape T based on inputted character information as the process tape T and the ink ribbon R are fed. The cutting section has the full cutter 33, the half cutter 35, a full-cutter motor 32, and a half-cutter motor 34 and performs a full-cutting operation and a half-cutting operation on the printed process tape T. Note that the full-cutter motor and the half-cut motor serve to drive the full cutter and the half cutter, respectively. The braille-characters embossing section has the solenoids 50, the embossing pins 48, and the embossing-feeding motor 43 and embosses braille-characters data on the tape piece Ta based on character information as the tape piece Ta is fed. The detecting section has various sensors such as the tape discriminating sensor 23 and the tip-end detecting mechanism 46 and performs various detections. The driving section has a display driver 66, a head driver 67, a printing-feeding motor driver 68, a cutter motor driver 69, an embossing driver 70, and an embossing-feeding motor driver 71 and drives each of the above-described sections. The controlling section is connected to the sections and controls the label forming apparatus entirely.

The controlling section 60 has a CPU 73, a ROM 74, a RAM 75, and an IOC 76 (Input Output Controller), all of which are connected to one another through an internal bus 77. The CPU 73 inputs various signals and data from each of the sections in the label forming apparatus 1 through the IOC in accordance with control programs of the ROM 74. The CPU processes various data of the RAM 75 based on the inputted various signals and data and outputs the various signals and data to each of the sections in the label forming apparatus 1 through the IOC 76, to thereby control an ink-characters printing process and a braille-characters embossing process.

This controlling operation makes it possible to perform various operations on the process tape T. It is, of course, possible not only to print the process tape T with ink characters, cut it out into a tape piece Ta, and emboss it in braille to obtain a tape piece Ta with ink characters printed and braille characters embossed concurrently thereon, but also to obtain a tape piece Ta with only ink characters printed, but without braille-characters embossed thereon. It is further possible to obtain a tape piece Ta with only braille characters, but without the ink-characters printed thereon. Note that the processed tape piece Ta is to be affixed to an accompanying object to serve as a label for both ink characters and braille characters, a label for ink characters, or a label for braille characters, as the case may be.

Referring to FIG. 5, description will now be made about the tape piece Ta to be inserted into the embossing-tape inserting section 11. The tape piece Ta in a strip shape formed after the process tape T being cut is formed into a label part 80 to be affixed to an accompanying object and a margin 81 formed at the tip-end part thereof by the half-cut line 82 along which only the recording tape Sr has been cut. On the trail of this half-cut line 82, the label part 80 can be peeled off the peeling tape Sp at the half-cut line as a sign and affixed to an accompanying object.

In the present embodiment, on the other hand, since the printed tape piece Ta is to be manually inserted into the braille-characters embossing section 64, it is designed that the margin 81 has tape-insertion indicating information 85 for indicating an inserting direction of the tape piece Ta printed thereon (see FIG. 5). When the tape piece Ta having a tape width of 24 mm is used, the label part 80 has a printing area 83 in which ink characters are printed by the print head 21 and a braille-characters embossing area 84 in which braille characters are embossed biased to the half area of the tape traveling path 36 on the cartridge mounting section 6 side in the width direction. Therefore, when the tape piece Ta is manually inserted in a wrong direction, braille characters are not embossed on the braille-characters embossing area 84. For this reason, the margin 81 has the tape-insertion indicating information 85 for indicating the inserting direction into the embossing-tape inserting section 11 printed thereon. The tape-insertion indicating information 85 includes direction indicating information 85a for indicating a manual inserting direction, braille-characters image information 85b for displaying braille-characters image, and top-and-bottom-direction indicating information for indicating the top-and-bottom-direction of braille characters. The direction indicating information 85a is printed on the margin such that it corresponds to the position of the embossing unit 41 in the width direction when the tape piece Ta is manually inserted.

In other words, the direction indicating information 85a is printed biased to the half area of the tape piece Ta on the braille-characters embossing area 84 side in the tape-width direction and designed to indicate the embossing unit 41. Furthermore, the direction indicating information 85a is printed in an arrow shape, and the character of “INSERT” representing the meaning of the arrow is printed therein. The top-and-bottom-direction indicating information 85c is printed on the rear side of the direction indicating information 85a and has a character representing “UPPER SIDE” printed therein. In addition, the top-and-bottom-direction indicating information surrounds the braille-characters image information 85b. The braille-character images information 85b includes those imitating a six-point braille character (braille character represented by six points). In the present embodiment, the image of a braille character representing a hiragana character “SA” is printed.

In the process tape Ta fed out from the tape cartridge C, the tape-insertion indicating information 85 and a desired image are printed on the margin 81 and the printing area 83, respectively. The half cutter 35 which cuts only the recording tape Sr cuts the boundary between the tape-insertion indicating information 85 and the printing area 83 in the width direction of the process tape Ta. Thereafter, the printed part of the process tape Ta is cut off by the full cutter 33 and ejected from the printing-tape ejecting slot 18 by the ejecting mechanism.

Next, description will be made about the embossing-tape inserting section 11 to which the invention of the present embodiment is applied. The embossing-tape inserting section 11 recessed in the apparatus casing 3 has a base plate 87 as a part of the apparatus casing 3, which communicates with the tape traveling path 36, the manual inserting guide 13 composed of a movable guide 13a which moves in accordance with a tape width of the tape piece Ta and a fixed guide 13b, an inserting slot 86 (see FIG. 1) where the tape piece Ta is manually inserted into the embossing assembly 40, and the insertion-part indicating information 14 which represents the embossing-tape inserting section 11 and indicates the inserting direction into the embossing-tape inserting section 11.

The inserting slot 86 serves as the boundary between the embossing-tape inserting section 11 and the embossing assembly 40 and is formed in a horizontal slit shape. The inserting slot is larger in thickness than the tape piece Ta, which enables the inserting slot to smoothly receive the tape piece Ta. Furthermore, the inserting slot 86 is provided at the upstream end of the tape traveling path 36, and the movable guide 13a is disposed at a position adjacent to the upstream side thereof. The base plate 87 communicates with the tape traveling path 36 through the inserting slot 86 and is obliquely formed toward the inserting slot 86. In addition, the surface of the base plate is formed in a flat shape so as to obviate possible obstructions when inserting the tape piece Ta. The manual inserting guide 13 is vertically provided on both sides in the inserting direction of the base plate 87 in a standing manner, and the fixed guide 13b serves also as the side wall (apparatus casing 3) of the recessed embossing-tape inserting section 11. Furthermore, the movable guide 13a is slidable in the tape width direction. When the movable guide 13a is fully slided into the left side, a guide width corresponding to the tape piece Ta having a small width can be obtained. On the other hand, when the movable guide 13a is fully slided into the right side, a guide width corresponding to the tape piece Ta having the maximum tape width can be obtained.

Furthermore, the movable guide 13a and the fixed guide 13b are composed of a position controlling section 90 for controlling the positions of respective width ends of the inserted tape piece Ta in the width direction thereof, a width expanding section communicating with the upstream end of the position controlling section 90 and gradually expanding the guide width toward the upstream side, and an introducing section 92 communicating with the upstream end of the width expanding section and permitting the manual insertion of the tape piece Ta. Note that the position controlling section, the width expanding section, and the introducing section are sequentially arranged from the downstream end in the inserting direction. According to this configuration, it is possible to easily introduce the tape piece Ta into the introducing section 92 whose width is larger than that of the tape piece Ta. The width expanding section 91 introduces the tape piece Ta into the position controlling section 90 along the guide surface as the tape piece Ta is forwarded to the downstream side. The tape width of the tape piece Ta is position-controlled by the position controlling section 90 and inserted into the inserting slot 86.

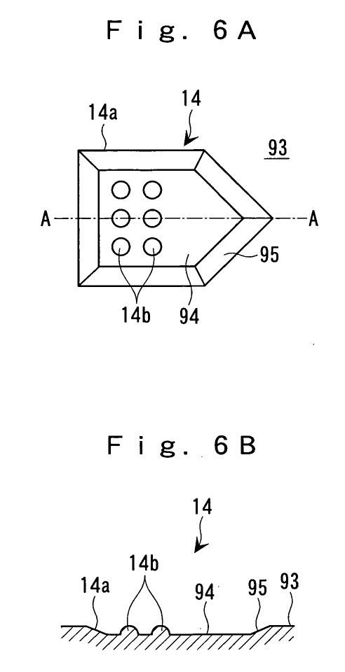

As shown in FIGS. 5, 6A, and 6B, the insertion-part indicating information 14 includes direction indicating information 14a for indicating the inserting direction and braille-characters image information 14b for displaying an image of a braille character. The insertion-part indicating information is recessed in a position where visibility is not interfered, namely, in the base plate 87 between the movable plate 13a and the fixed guide 13b. Therefore, it is possible that the user is easily notified of the insertion-part indicating information 14. In addition, since the insertion-part indicating information 14 is directly recessed in the base plate 87, the inserted tape piece Ta is prevented from getting caught on the projecting part. The insertion-part indicating information 14 is provided such that it is positioned on the near side of the tape inserting section 11 and corresponds to the position (left side) where the embossing unit 41 is disposed in the width direction of the tape traveling path 36. In other words, the insertion-part indicating information 14 has a width smaller than that of the tape piece Ta and is provided biased to the half area of the tape traveling path on the cartridge mounting section 6 side. Furthermore, the insertion-part indicating information 14 and the direction indicating information 85a of the tape-insertion indicating information 85 are similar in design.

The direction indicating information 14a is formed in an arrow shape representing the inserting direction and provided such that it corresponds to the embossing unit 41 facing on the tape traveling path 36 in the width direction. The edge part of the direction indicating information 14a is formed in such a manner as to have a down slope surface 95 between a base plate surface 93 and a recessed surface 94. The braille-characters image information 14b forms a convex part imitating a six-point braille character and disposed in such a manner as to be surrounded by the direction indicating information 14a. The braille-characters image information 14b of the present embodiment is formed in a shape similar to a braille character corresponding to a hiragana character “ME” and projects toward the recessed surface 94 and provided at a level identical with or lower than that of the base plate 93. Therefore, the tape piece Ta is prevented from getting caught on the braille-characters image information 14b.

Note that, although the insertion-part indicating information 14 is recessed in the present embodiment, it may be printed on an adhesive seal and the adhesive tape affixed to the embossing-tape inserting part 11. Furthermore, the insertion-part indicating information 14 and the tape-insertion indicating information 85 may be similar in design.

According to the above-described configuration, since the insertion-part indicating information 14 is recessed in the embossing-tape inserting section 11, the user cannot misidentify the inserting position and the inserting direction of the tape piece Ta. In other words, after visually recognizing the tape-insertion indicating information 85 and the insertion-part indicating information 14, the user can insert the tape piece Ta with the tape-insertion indicating information 85 put on the leading edge without misidentifying the position in the inserting direction and the position in the width direction relative to the embossing-tape inserting section 11. Accordingly, the user can properly insert the tape piece Ta into the embossing assembly 40 with full confidence and obtain a tape piece Ta with desired braille-characters embossed thereon.

It is further understood by those skilled in the art that the foregoing is the preferred embodiment of the present invention, and that various changes and modifications may be made without departing from the spirit and scope thereof.

What is claimed is:

1. A sheet processing apparatus in which a braille character is embossed on a process sheet, which is manually inserted from a sheet inserting part provided at one end of a sheet traveling path, by a braille-characters embossing device facing on the sheet traveling path, wherein
the sheet inserting part is provided with visually recognizable insertion-part indicating information as an indication for inserting the process sheet.

2. The sheet processing apparatus according to claim 1, wherein
the braille-characters embossing device is disposed at a position biased to one side in the width direction of the sheet processing apparatus, and
the insertion-part indicating information is provided so as to correspond to the position of the braille-characters embossing device disposed in the width direction of the sheet traveling path.

3. The sheet processing apparatus according to claim 1, wherein
the insertion-part indicating information includes direction indicating information for indicating an inserting direction.

4. The sheet processing apparatus according to claim 1, wherein
the insertion-part indicating information includes braille-characters image information for displaying braille-character images.

5. The sheet processing apparatus according to claim 1, wherein
the insertion-part indicating information is recessed in a base plate of the sheet inserting part communicating with the sheet traveling path.

6. The sheet processing apparatus according to claim 1, further comprising a printing device for printing an ink character on the process sheet, wherein
the printing device prints, on the tip-end part of the process sheet in the inserting direction thereof, sheet-insertion indicating information on the direction of insertion into the sheet insertion part.

7. The sheet processing apparatus according to claim 6, wherein
the sheet insertion part includes a guide device for guiding the insertion of the process sheet, and
the printing device performs a printing operation such that the insertion-part indicating information and the sheet-insertion indicating information of the process sheet whose insertion is guided by the guide device correspond to each other in the width direction of the sheet traveling path.

8. The sheet processing apparatus according to claim 6, wherein
the process sheet is composed of a recording sheet whose rear surface is coated with an adhesive agent and a peeling sheet affixed to the rear surface of the recording sheet with the adhesive agent,
a half-cutting device for cutting only the recording sheet of the process sheet at the tip-end part in the inserting direction thereof is further provided, and
the printing device prints the sheet-insertion indicating information on a margin of the recording sheet which is cut by the half-cutting device.

9. The sheet processing apparatus according to claim 6, wherein
the sheet-insertion indicating information and the insertion-part indicating information are similar in design.
